(19) United States
(12) Patent Application Publication
(10) Pub. No.: US 2026/0141228 A1
(43) Pub. Date: May 21, 2026

(54) STORAGE DEVICE, HOST, AND DATA PROCESSING METHOD OF STORAGE DEVICE AND HOST

(71) Applicant: Samsung Electronics Co., Ltd., Suwon-si (KR)

(72) Inventors: Kun ZHANG, Xi'an (CN); Jongtae PARK, Xi'an (CN); Fei DONG, Xi'an (CN)

(73) Assignee: Samsung Electronics Co., Ltd., Suwon-si (KR)

(21) Appl. No.: 18/980,696

(22) Filed: Dec. 13, 2024

(30) Foreign Application Priority Data
Nov. 19, 2024 (CN) 202411658091.8

(51) Int. Cl. G06N 3/0495

(52) U.S. Cl. CPC G06N 3/0495

(57) ABSTRACT

The present disclosure provides a storage device, a host, and processing data methods of the storage device and the host. The data processing method of the storage device includes: receiving, by the storage device, input data to be processed by the storage device from a host; in response to a parameter updating request of the host in model training, calculating, by the storage device, deep neural network (DNN) model parameters using the input data; transmitting, by the storage device, at least a portion of the calculated DNN model parameters to the host.

This application is based on and claims priority under 35 U.S.C. § 119 to Chinese Patent Application No. 202411658091.8 filed on Nov. 19, 2024, in the Chinese Intellectual Property Office, the disclosure of which is incorporated by reference herein in its entirety.

### TECHNICAL FIELD

The present disclosure relates to data processing, and more specifically, to a storage device, a host, and processing data methods of the storage device and the host.

### BACKGROUND ART

Nowadays, increasing the size of a Deep Neural Network (DNN) model is crucial for improving an accuracy of the DNN model. However, due to the gradual growth in the size of the DNN models in recent years (e.g., by a scale of about 10 times per year), more storage resources are required for parameter data during the training of the DNN model. If the model training relies only on a memory of the graphics processing unit (GPU), an Out Of Memory (OOM) problem or a Memory Wall problem can occur during data processing, thereby affecting a data processing efficiency of the model training.

### SUMMARY

In order to address at least the above problems and/or drawbacks, embodiments of the present disclosure provide a storage device, a host, and data processing methods of the storage device and the host.

According to a first aspect of at least one embodiment of the present disclose, a data processing method of a storage device is provided, which comprising: receiving, by the storage device, input data to be processed by the storage device; calculating, by the storage device, deep neural network (DNN) model parameters using the input data in response to a parameter updating request of a host in model training; and transmitting, by the storage device, at least a portion of the calculated DNN model parameters to the host.

Alternatively, the storage device comprises a non-volatile memory, wherein the storage device comprises a non-volatile memory, wherein the data processing method further comprises compressing, by the storage device, the input data, and storing the compressed input data in the non-volatile memory, wherein, in response to the parameter updating request of the host in the model training, the calculating, by the storage device, the DNN model parameters using the input data comprises decompressing the compressed input data stored in the non-volatile memory in response to the parameter updating request, and calculating the DNN model parameters using the decompressed input data, and wherein the data processing method further comprises determining, by the storage device, the calculated DNN model parameters as updated DNN model parameters in response to a storage request of the host, compressing the updated DNN model parameters, and storing the compressed DNN model parameters in the non-volatile memory.

Alternatively, the receiving, by the storage device, the input data to be processed by the storage device from the host comprises: receiving the input data in units of data blocks, wherein a compression rate of at least some of the data blocks satisfy a compression rate threshold condition.

Alternatively, the calculating, by the storage device, the DNN model parameters using the input data in response to the parameter updating request of the host in the model training comprises: calculating the DNN model parameters using the input data and gradient data received from the host.

Alternatively, in response to the parameter updating request of the host, the calculating the DNN model parameters using the input data and the gradient data received from the host comprises: iteratively calculating the DNN model parameters using the input data and the gradient data received from the host in response to the parameter updating request, such that, in a t-th iteration calculation, the storage device calculates t-th DNN model parameters using t-th iteration data and t-th gradient data received from the host, wherein t is an integer greater than or equal to 1 and less than or equal to the number of iterations of model training of the host, wherein the t-th iteration data is the input data when t is equal to 1, and the t-th iteration data is (t−1)-th DNN model parameters when t is not equal to 1.

Alternatively, the t-th iteration data comprises momentum, momentum variance, and weight, wherein the calculating the t-th DNN model parameters using the t-th iteration data and the t-th gradient data received from the host comprises: obtaining momentum and momentum variance in the t-th DNN model parameters, by performing a calculation operation using the t-th gradient data and the momentum and the momentum variance comprised in the t-th iteration data; obtaining weight in the t-th DNN model parameters, by performing a calculation operation using the momentum and the momentum variance in the t-th DNN model parameters and the weight in the t-th iteration data.

According to a second aspect of at least one embodiment of the present disclose, a data processing method of a host is provided, which comprising: transmitting, by the host, input data to be processed by a storage device to the storage device; transmitting, by the host, a parameter updating request to the storage device in response to starting to perform training on a deep neural network (DNN) model, wherein the parameter updating request is configured to request the storage device to calculate DNN model parameters using the input data; and receiving, by the host, at least a portion of the calculated DNN model parameters from the storage device.

Alternatively, the data processing method further comprises: transmitting a storage request for DNN model parameters to the storage device in response to determining completion of model training, wherein the storage request is configured to initiate the storage device to determine the calculated DNN model parameters as updated DNN model parameters, compress the updated DNN model parameters, and store the compressed DNN model parameters in a non-volatile memory of the storage device.

Alternatively, the data processing method further comprises: dividing, by the host, data of the DNN model parameters into a plurality of data blocks; determining, by the host, a compression rate of each data block; determining, by the host, data comprised in a data block, of which the compression rate satisfies a compression rate threshold condition, as the input data.

Alternatively, the transmitting, by the host, the input data to be processed by the storage device to the storage device comprises: adding, by the host, the data block, of which the compression rate satisfies the compression rate threshold condition, into a candidate queue; sequentially transmitting, by the host, the input data in the candidate queue to the storage device in units of data block in response to a determination that a utilization rate of a central processing unit (CPU) of the host satisfies a CPU utilization threshold condition and/or that a utilization rate of a memory of the host satisfies a memory utilization threshold condition.

Alternatively, the data processing method further comprises: calculating, by the host, gradient data and transmitting the gradient data to the storage device in response to starting to perform training on the DNN model.

Alternatively, in response to starting to perform training on the DNN model, calculating, by the host, the gradient data and transmitting the gradient data to the storage device comprises: calculating, by the host, t-th gradient data and transmit the t-th gradient data to the storage device, wherein the t-th gradient data is used for the storage device to calculate t-th DNN model parameters based on t-th iteration data in t-th iteration training calculation, wherein t is an integer greater than or equal to 1 and less than or equal to the number of iterations of model training of the host, wherein the t-th iteration data is the input data when t is equal to 1, and the t-th iteration data is (t−1)-th DNN model parameters when t is not equal to 1.

According to a third aspect of at least one embodiment of the present disclose, a storage device is provided, which comprising: a receiving unit configured to receive input data to be processed by the storage device from a host; a processing unit configured to calculate deep neural network (DNN) model parameters using the input data in response to a parameter updating request of a host in model training; a transmitting unit configured to transmit at least a portion of the calculated DNN model parameters to the host.

Alternatively, the storage device comprises a non-volatile memory, wherein the processing unit is further configured to: compress the input data and store the compressed input data in the non-volatile memory, wherein, in response to the parameter updating request of the host in the model training, the processing unit is configured to calculate the DNN model parameters using the input data by: in response to the parameter updating request, decompressing the compressed input data stored in the non-volatile memory, and calculating the DNN model parameters using the decompressed input data, and wherein the processing unit is further configured to: in response to a storage request of the host, determine the calculated DNN model parameters as updated DNN model parameters, compress the updated DNN model parameters and store the compressed DNN model parameters in the non-volatile memory.

Alternatively, the receiving unit is configured to receive the input data to be processed by the storage device from the host, by receiving the input data in units of data blocks, wherein a compression rate of each data block satisfies a compression rate threshold condition.

Alternatively, the processing unit is configured to calculate the DNN model parameters using the input data, in response to the parameter updating request of the host in the model training, by calculating the DNN model parameters using the input data and gradient data received from the host.

Alternatively, the processing unit is configured to, in response to the parameter updating request of the host, calculate the DNN model parameters using the input data and the gradient data received from the host, by: in response to the parameter updating request, iteratively calculating the DNN model parameters using the input data and the gradient data received from the host, wherein, in a t-th iteration calculation, the processing unit is configured to calculate t-th DNN model parameters using t-th iteration data and t-th gradient data received from the host, wherein t is an integer greater than or equal to 1 and less than or equal to the number of iterations of model training of the host, wherein the t-th iteration data is the input data when t is equal to 1, and the t-th iteration data is (t−1)-th DNN model parameters when t is not equal to 1.

Alternatively, the t-th iteration data comprises momentum, momentum variance, and weight, wherein the processing unit is configured to calculate the t-th DNN model parameters using the t-th iteration data and the t-th gradient data received from the host by:
obtaining momentum and momentum variance in the t-th DNN model parameters, by performing a calculation operation using the t-th gradient data and the momentum and the momentum variance comprised in the t-th iteration data; obtaining weight in the t-th DNN model parameters, by performing a calculation operation using the momentum and the momentum variance in the t-th DNN model parameters and the weight in the t-th iteration data.

According to a fourth aspect of at least one embodiment of the present disclose, a host is provided, which comprising: a transmitting unit configured to transmit input data to be processed by a storage device to the storage device, and transmit a parameter updating request to the storage device in response to starting to perform training on a deep neural network (DNN) model, wherein the parameter updating request is used to request the storage device to calculate DNN model parameters using the input data; and a receiving unit configured to receive at least a portion of the calculated DNN model parameters from the storage device.

Alternatively, the transmitting unit is further configured to: in response to determining completion of model training, transmit a storage request for DNN model parameters to the storage device, wherein the storage request is configured to initiate the storage device to determine the calculated DNN model parameters as updated DNN model parameters, compress the updated DNN model parameters, and store the compressed DNN model parameters in a non-volatile memory of the storage device.

Alternatively, the host further comprises a data unit configured to: divide data of the DNN model parameters into a plurality of data blocks; determine a compression rate of each data block; assign data comprised in a data block, of which the compression rate satisfies a compression rate threshold condition, as the input data.

Alternatively, the transmitting unit is configured to transmit the input data to be processed by the storage device to the storage device by: adding the data block, of which the compression rate satisfies the compression rate threshold condition, into a candidate queue; in response to a utilization rate of a central processing unit (CPU) of the host satisfying a CPU utilization threshold condition and/or a utilization rate of a memory of the host satisfying a memory utilization threshold condition, sequentially transmit the input data in the candidate queue to the storage device in units of data block.

Alternatively, the host comprises a processing unit configured to calculate gradient data in response to starting to perform training on the DNN model, wherein the transmitting unit is configured to transmit the gradient data to the storage device, and wherein the gradient data is configured to enable the storage device to calculate the DNN model parameters based on the input data.

Alternatively, the processing unit and the transmitting unit are configured to, in response to starting to perform training on the DNN model, calculate the gradient data and transmit the gradient data to the storage device by: calculating, by the processing unit, t-th gradient data and transmitting, by the transmitting unit, the t-th gradient data to the storage device, wherein the t-th gradient data is used for the storage device to calculate t-th DNN model parameters based on t-th iteration data in t-th iteration training calculation, wherein t is an integer greater than or equal to 1 and less than or equal to the number of iterations of model training of the host, wherein the t-th iteration data is the input data when t is equal to 1, and the t-th iteration data is (t−1)-th DNN model parameters when t is not equal to 1.

According to a fifth aspect of at least one embodiment of the present disclosure, a system to which a storage device is applied, which comprising: a main processor; a memory; and the storage device, wherein the main processor is configured to control the storage device to perform the data processing method as described above, and/or the main processor is configured to perform the data processing method as described above.

According to a sixth aspect of at least one embodiment of the present disclosure, a host storage system is provided, which comprising: a storage device, and a host configured to control the storage device according to the data processing method as described above.

According to a seventh aspect of at least one embodiment of the present disclosure, a memory system is provided, which comprising: a memory device, and a memory controller configured to control the memory device to perform the data processing method as described above.

According to an eighth aspect of at least one embodiment of the present disclosure, a universal flash storage UFS system is provided, which comprising: a UFS Host; a UFS device; and a UFS interface that connects the UFS host with the UFS device, wherein the UFS device is configured to perform the data processing method as described above, and/or the UFS host is configured to perform the data processing method as described above.

According to a ninth aspect of at least one embodiment of the present disclosure, an electronic apparatus is provided, which comprising: at least one processor; and at least one memory storing computer executable instructions, wherein, the computer executable instructions, when being executed by the at least one processor, cause the at least one processor to perform the data processing method as described above.

According to a tenth aspect of at least one embodiment of the present disclosure, a computer-readable storage medium is provided, wherein, instructions in the computer-readable storage medium, when being executed by at least one processor, cause the at least one processor to perform the data processing method described above.

The storage device, the host, and the data processing methods of the storage device and the host according to at least one embodiments of the present disclosure have at least the following technical effects:
Parameter calculation in DNN model training is performed at the storage device side, only necessary data is transferred between the host and the storage device, and a large amount of data is stored in the storage device, which can greatly reduce unnecessary data transfer overhead and memory footprint of the host, and thus, it can achieve an unprecedented model scale on limited resources, reduce CPU and GPU calculation overhead and data movement, and save storage space of the host, thereby solving the OOM problem or the memory wall problem. In addition, the host can recognize sparse tensor data to store the same in the storage device, enabling the saving of storage resources without affecting a quality of the data and reducing unnecessary storage space occupation.

It should be understood that the general description above and the detailed description in the following are only illustrative and explanatory, and cannot limit the present disclosure.

### BRIEF DESCRIPTION OF THE DRAWINGS

The foregoing and other aspects, features and advantages of certain embodiments of the present disclosure will become more apparent by the following description in conjunction with the accompanying drawings, wherein:

FIG. 1 is a schematic diagram illustrating an implementation of the related data processing method;

FIG. 2 is a flowchart illustrating a data processing method of a storage device according to at least one embodiment of the present disclosure;

FIG. 3 is a schematic diagram illustrating an example processing of a data processing method according to at least one embodiment of the present disclosure;

FIG. 4 is a schematic diagram illustrating an iterative calculation processing according to at least one embodiment of the present disclosure;

FIG. 5 is a flowchart illustrating a data processing method of a host according to at least one embodiment of the present disclosure;

FIG. 6 is a schematic diagram illustrating an example implementation of a data processing method of a host according to at least one embodiment of the present disclosure;

FIG. 7 is a schematic diagram illustrating tensor data in an example Visual Geometry Group 16 network;

FIG. 8 is a schematic diagram illustrating transmitting input data according to at least one embodiment of the present disclosure;

FIG. 9 is a block diagram illustrating a storage device according to at least one embodiment of the present disclosure;

FIG. 10 is a block diagram illustrating a host according to at least one embodiment of the present disclosure;

FIG. 11 is a schematic diagram of a system 1000 to which a storage device is applied, according to at least one embodiment;

FIG. 12 is a block diagram of a host storage system 10 according to an example embodiment;

FIG. 13 is a block diagram of a memory system 15 according to at least one embodiment of the present invention;

FIG. 14 is a diagram of a UFS system 2000 according to at least one embodiment;

FIG. 15 is a schematic diagram illustrating memory usage statistics data of various networks; and

FIG. 16 is a schematic diagram illustrating a comparison of the related data processing method and a data processing method according to at least one embodiment of the present disclosure.

### DETAILED DESCRIPTION OF EMBODIMENTS

In order to enable those ordinary skilled in the art to better understand the technical solution of the present disclosure, technical solutions in embodiments of the present disclosure will be described clearly and completely in combination with the accompanying drawings.

The terms “include/including” or “comprise/comprising” used in this specification, indicate the presence of stated features, integers, steps, operations, elements, components, and/or combinations thereof, but do not preclude the presence or addition of one or more other features, integers, steps, operations, elements, components, and/or combinations thereof. It should be understood that, although the terms “first”, “second”, “third”, etc. are used to describe various information, the information should not be limited by these terms. These terms are only used to distinguish one type of information from another type of information. For example, without departing from the scope of the present disclosure, first information may be referred to as second information; and similarly, second information may be referred to as first information. As used herein, the term “in response to” may be understood to mean “when”, “while”, or “if” depending on the context.

In addition, “at least one of” appearing in the present disclosure all means that there are three kinds of juxtaposition situations: “any one of”, “a combination of any number of”, and “all of”. For example, “including at least one of A and B” includes the following three juxtaposition situations: (1) including A; (2) including B; (3) including A and B. As another example, “performing at least one of steps 1 and 2”, that is, means the following three juxtaposition situations: (1) performing step 1; (2) performing step 2; (3) performing steps 1 and 2.

Unless otherwise defined, all terms used herein (including technical and scientific terms) have the same meaning as they are understood based on the disclosure of the present application and as they are commonly understood by those of ordinary skill in the art to which the present disclosure pertains, and are not to be interpreted in an idealized or overly formalistic manner. Herein, the use of the term “may” with respect to an example or embodiment (e.g., “may include”) indicates the existence of at least one example or embodiment that includes or implements such feature, and all examples are not limited to this. Unless otherwise expressly defined, terms in the singular form also include the plural form.

Unless otherwise defined, functional elements, including those modified with terms like “unit”, “module”, “-or/-er”, etc. used in description or drawings in the specification and/or function blocks illustrated in drawings may be implemented in the form of processing circuitry including software, hardware, or a combination thereof configured to perform specific functions. For example, the processing circuitry more specifically may include, but is not limited to, a central processing unit (CPU), an arithmetic logic unit (ALU), a digital signal processor, a microcomputer, a field programmable gate array (FPGA), a System-on-Chip, (SoC), a programmable logic unit, a microprocessor, application-specific integrated circuit (ASIC), etc. and/or may include active and/or passive electrical components such as transistors, resistors, capacitors, etc., and/or electronic circuits including one or more of said components. Division of functionality for the processing circuitry may be provided to specific functional elements, as described in further detail below.

Additionally, according to the example embodiments, examples of computer-readable storage medium include: read-only memory (ROM), random-access programmable read-only memory (PROM), electrically erasable programmable read-only memory (EEPROM), random-access memory (RAM), dynamic random-access memory (DRAM), static random-access memory (SRAM), flash memory, nonvolatile volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk memory, hard disk drive (HDD), solid-state drive (SSD), card memory (such as, a multimedia card, a Secure Digital (SD) card, or an Extreme Digital (XD) card), magnetic tapes, floppy disks, magneto-optical data storage devices, optical data storage devices, hard disks, solid state disks, and any other devices, the any other devices being configured to store a computer program, as well as any associated data, data files, and data structures, in a non-transitory manner, and to provide the computer program and any associated data, data files and data structures to a processor or computer, to cause the processor or computer to execute the computer program. The computer program in the computer-readable storage medium may be run in an environment deployed in an electronic apparatus such as a client, a host, an agent, a server, etc. Furthermore, in one example, the computer program and any associated data, data files, and data structures are distributed across a networked computer system, such that the computer program and any associated data, data files, and data structures are distributed via the one or more processors or computers to be stored, accessed, and executed in a distributed manner.

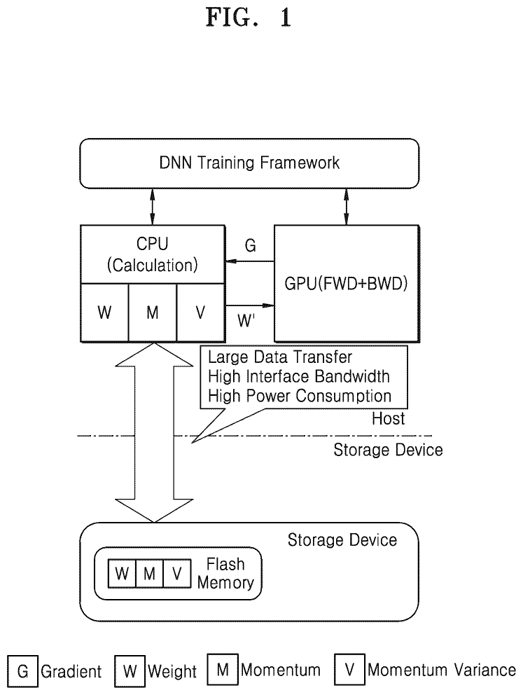

In order to solve an Out Of Memory (OOM) problem or memory wall problem in data processing for model training (especially for very large model training), two typical attempts (i.e., ZeRO-Offload and ZeRO-Infinity technologies, of Zero Redundancy Optimizer (ZeRO)) have been proposed. A concept of the ZeRO-Offload technology is to offload parameter data and calculation to a central processing unit (CPU), so that the CPU performs functions of an optimizer and calculator, therefore, the model training not only uses the storage resources of the memory on the CPU side, but also the calculation resources on the CPU side, which reduces the memory usage of the GPU and the calculation pressure on the GPU. Similarly, a concept of the ZeRO-Infinity technology is to use all memory capacity to store parameter data, that is, to use all heterogeneous memories (GPU, CPU, and Non-Volatile Memory (NVMe)). Although these two technologies can partially solve the OOM problem and/or the memory wall problem, both have many drawbacks, such as the capacity of Dynamic Random Access Memory (DRAM) not satisfying the exponentially increasing capacity demand for model training, and/or the efficiency of data processing being degraded due to factors such as bus contention on DRAM (for example, the throughput of large model training is reduced due to the bus contention), the frequent and repetitive data transfers between the host and NVMe, an increase latency due to the interface bandwidth of the NVMe being lower than that of DRAM resulting in longer Input/Output (I/O) latency, etc. The related data processing method is described in detail below with reference to FIG. 1.

FIG. 1 is a schematic diagram illustrating an implementation of the related data processing method.

Referring to FIG. 1, when performing training on a deep neural network (DNN) model, a GPU on a host side needs to perform training operations such as weight initialization, forward (FWD) propagation, backward (BWD) propagation, gradient calculation, and weight updating, and there is a large memory overhead regarding model parameters during the calculation period of the GPU performing the training of the DNN model.

In the related data processing method, parameter data (e.g., a weight W, a momentum M, and a momentum variance V) of the DNN model is stored by using a memory of the GPU on the host side and a memory of a Solid State Disk (SSD) on the storage device side (e.g., Flash memory in FIG. 1), and an optimizer of the CPU on the host side performs a calculation operation using gradient data (e.g., a gradient G) received from the GPU and parameter data received from the SSD on the storage device side. Specifically, in response to starting the training of the Deep Neural Network (DNN) model, the GPU performs a gradient calculation operation to determine the gradient data and transmits the gradient data to the CPU for parameter calculation processing. The CPU may receive the gradient data from the GPU, read the parameter data stored in the flash memory of the SSD on the storage device side, and perform the parameter calculation operation using the received gradient data (e.g., the gradient G) and the read data (e.g., the weight W, the momentum M, and the momentum variance V). In the iterative processing of the training of the DNN model, the CPU needs to continuously read the parameter data from the SSD and/or store the parameter data to the SSD. Furthermore, the CPU transmits a calculation result (e.g., the updated weights W′) to the GPU for use in subsequent operations. With such data processing method, during the training process of the DNN model, the data transfer between the host side and the storage device side is frequent, and the host side needs to consume a large amount of calculation resources. Therefore, there is a need for an effective solution that can solve the above memory problems to improve the data processing efficiency.

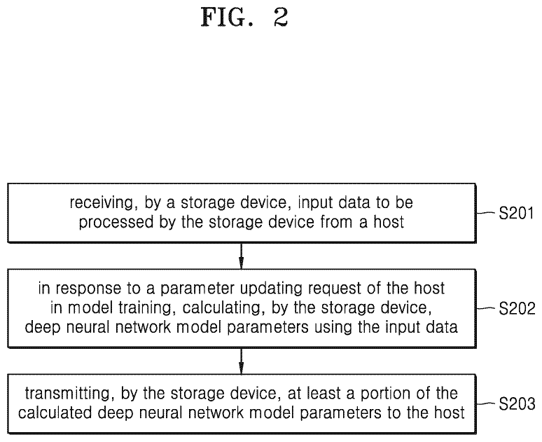

Accordingly, in order to at least address the various problems and/or deficiencies described above, a storage device, a host, and data processing methods of the storage device and the host, which use the storage device to perform parameter calculation in DNN model training are present proposed, which can achieve an unprecedented model scale on limited resources, reduce calculation overhead of the CPU and the GPU as well as data movement, and save storage space on the host, thereby solving the OOM problem or memory wall problem. Though a GPU is provided as an example, the example embodiments are not limited thereto; for example, other DNN configured parallel-processors may be included. The technical solutions according to embodiments of the present disclosure will be described in detail below with reference to FIGS. 2 to 14.

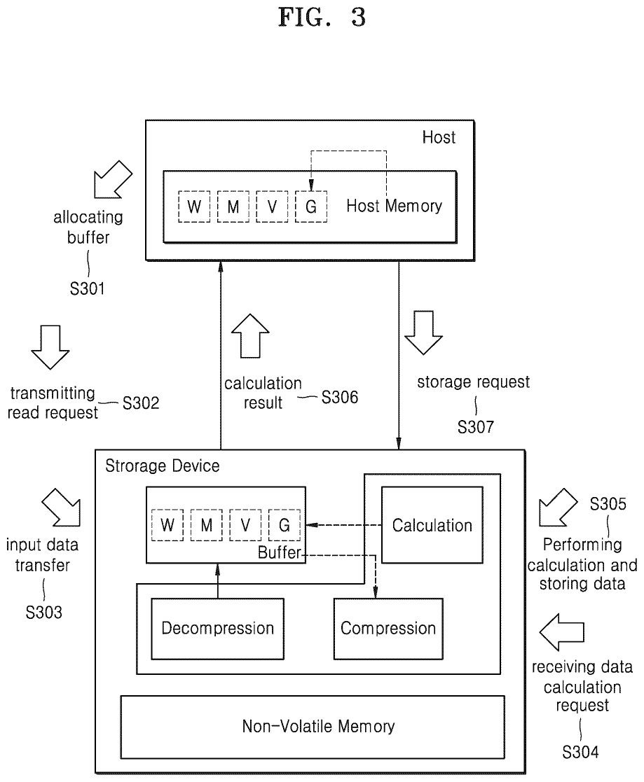

FIG. 2 is a flowchart illustrating a data processing method of a storage device according to at least one embodiment of the present disclosure. The data processing method of FIG. 2 is described in detail with reference to FIG. 3. FIG. 3 is a schematic diagram illustrating example processing of a data processing method according to at least one embodiment of the present disclosure.

Referring to FIG. 2, at operation S201, the storage device receives input data to be processed by the storage device. The data may be received from a host. For example, the storage device offloads, from the host, data of initial DNN model parameters to be processed by the storage device (such as, for example, a weight W, a momentum M, and a momentum variance V). Herein, although at least one embodiments only describe the DNN model parameters including the weight W, the momentum M, and the momentum variance V, the present disclosure is not limited thereto, and the DNN model parameters according to some of at least one embodiments may include various other parameters for training of the DNN model (such as, for example, an activation values, etc.), and in some embodiments may even include the gradient G.

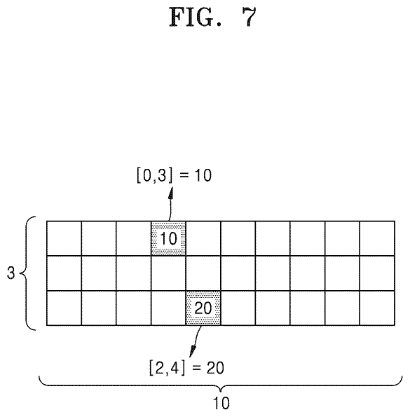

According to at least one embodiment, the storage device receives the input data in units of data blocks, wherein a compression rate of each data block satisfies a compression rate threshold condition. Specifically, since the data for the training of the DNN model may include a large amount of sparse tensor data, sparsity of the tensor data may be represented by the compression rate. For example, the compression rate may correspond to a ratio of zero elements (or non-zero elements) to all elements in the data, the number of zero elements (or non-zero elements), and the like. The details about the tensor data will be described below in connection with FIG. 7.

As an example, the compression rate increases as the proportion (or the number) of zero elements in the data increases. When a compression rate of a data block satisfies a compression rate threshold condition (e.g., the compression rate of the data block is greater than or equal to a preset compression rate threshold), data included in the data block may be processed and/or compressed by the storage device. Thus, the compression rate of the data block of the input data received by the storage device satisfies the compression rate threshold condition.

According to at least one embodiment, the storage device (e.g., SSD) includes a non-volatile memory, such as, for example, a flash memory (Flash) and the like. Although at least one embodiments according to the present disclosure only illustrate embodiments in which the storage device includes an SSD, the present disclosure is not limited thereto, and the storage device may include an SSD, an embedded memory, a removable external memory, and/or the like. Although at least one embodiments according to the present disclosure only illustrate embodiments in which the non-volatile memory includes a flash memory, the present disclosure is not limited thereto, and the non-volatile memory may include phase-change random access memory (PRAM), resistive random access memory (RRAM), and/or the like.

According to at least one embodiment, the data processing method may further include compressing the input data by the storage device and storing the compressed input data in the non-volatile memory. Specifically, since the input data may include the sparse data, the storage device—when storing the input data—may store the compressed input data into flash memory after compressing the input data, thereby saving storage space and bus bandwidth.

When the storage device stores the input data (e.g., the initial DNN model parameters) and/or after the storage device stored the input data (e.g., the initial DNN model parameters), at operation S202, in response to a parameter updating request of the host in the model training, the storage device calculates DNN model parameters using the input data.

According to at least one embodiment, since the storage device stores the compressed data, in response to the parameter updating request of the host in the model training, the calculating, by the storage device, the DNN model parameters using the input data includes decompressing the compressed input data stored in the non-volatile memory in response to the parameter updating request, and calculating the DNN model parameters using the decompressed input data.

As described above, the host, when performing model training, needs to update the DNN model parameters, and according to at least one embodiment, the host requests the storage device to calculate updated DNN model parameters. This step is described in detail below with reference to FIG. 3.

According to at least one embodiment, firstly, referring to FIG. 3, at operation S301, a host allocates buffers for the DNN model parameters (e.g., including the weight W, the momentum M, and the momentum variance V) in a storage device (e.g., an SSD in FIG. 3). In some embodiments, the host may further allocate a buffer for the gradient data G. For example, predetermined buffers may be allocated for each of the parameters of the weight W, the momentum M, the momentum variance V, and the gradient data G. Alternatively, the allocated buffers may be mapped to the memory of the host, such that the host may use the buffers in the storage device in the same manner as using the memory of the host.

At operation S302, the host transmits a read request to the storage device, so that the storage device reads the input data from the non-volatile memory of the storage device into the buffer. Specifically, since the storage device stored the input data in the non-volatile memory, the host may instruct the storage device to read the input data from the non-volatile memory.

At operation S303, the storage device transmits the input data from the volatile memory to the buffer. Specifically, the storage device decompresses the input data and stores the decompressed input data into the buffer for use.

At operation S304, a data calculation request is received from the host. Specifically, in response to the data calculation request, the storage device may add the data to be processed (e.g., data of the DNN model parameters in the buffer) into a calculation processing queue, to perform a calculation operation on the data to be processed.

Although FIG. 3 shows that the storage device receives the read request and the data calculation request from the host at operation S302 and operation S304, respectively, the storage device may receive only the parameter updating request and perform the respective operation of FIG. 3, and the present disclosure is not limited thereto. According to at least one embodiment, in response to the parameter updating request of the host in the model training, the calculating, by the storage device, the DNN model parameters using the input data includes: in response to the parameter updating request of the host, calculating the DNN model parameters using the input data and the gradient data received from the host.

At operation S305, a calculation operation is performed using the input data, and the calculated data (e.g., the calculated DNN parameters) is stored in the buffer.

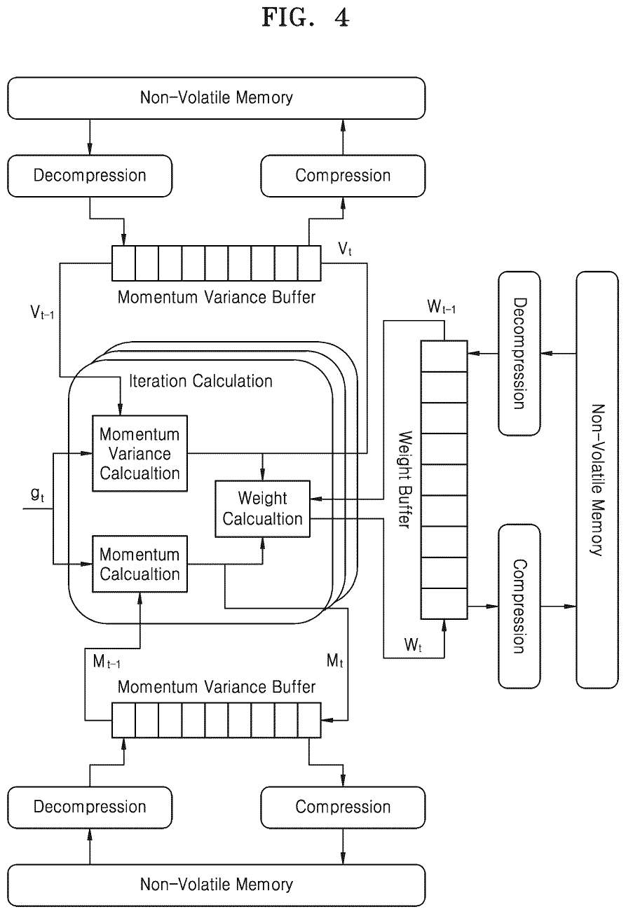

According to at least one embodiment, the calculating the DNN model parameters using the input data and the gradient data received from a host is described in detail below with reference to FIG. 4.

FIG. 4 is a schematic diagram illustrating an iterative calculation processing according to at least one embodiment of the present disclosure.

Referring to FIG. 4, in response to the parameter updating request, the storage device iteratively calculates the DNN model parameters using the input data and the gradient data received from the host. In FIG. 4, “t” is an integer greater than or equal to 1 and less than or equal to the number of iterations of model training of the host.

According to at least one embodiment, when the host performs the DNN model training, a DNN training framework determines whether to complete the model training (that is, whether to end the model training). For example, during the model training processing, when an error of an output of the DNN model satisfies a predetermined error condition (e.g., is less than or equal to the predetermined error condition), the DNN training framework may determine that the model training is completed, and accordingly, the iterative calculation of the model training ends. As another example, during the model training processing, when the number of iterations of the DNN model training reaches a predetermined number of iterations, the DNN training framework may determine to complete the model training. The determination regarding the number of iterations for model training may not be limited to the above-described manner, which is not described in detail.

Referring to FIG. 4, when the storage device performs a first iteration calculation, the input data is moved from the non-volatile memory to the buffer, as described above. Then, the input data is used as first iteration data (including an initial momentum m₀, an initial momentum variance v₀, and an initial weight w₀), first gradient data g₁ is received from the host, and first DNN model parameters are calculated using the first iteration data and the first gradient data g₁.

According to at least one embodiment, the first DNN model parameters may include a first momentum m₁, a first momentum variance v₁, and a first weight w₁, and the first DNN model parameters may be used as second iteration data in second iteration calculation.

Specifically, referring to FIG. 4, the storage device may obtain the first momentum m₁ in the first DNN model parameters by performing a calculation operation using the first gradient data g₁ and the initial momentum m₀ included in the first iteration data. The storage device may obtain the first momentum variance v₁ in the first DNN model parameters by performing a calculation operation using the first gradient data g₁ and the initial momentum variance v₀ included in the first iteration data. The storage device may obtain the first weight w₁ in the first DNN model parameters by performing a calculation operation using the first momentum m₁ and the first momentum variance v₁ in the first DNN model parameters and the initial weight w₀ included in the first iteration data.

According to at least one embodiment, the storage device may store the first DNN model parameters into one or more buffers. For example, the first momentum m₁, the first momentum variance v₁, and the first weight w₁ included in the first DNN model parameters are stored in a momentum buffer, a momentum variance buffer, and a weight buffer, respectively, for use in subsequent iterative calculations.

By analogy, in a t-th iteration calculation, the storage device calculates t-th DNN model parameter using t-th gradient data received from the host and t-th iteration data.

Referring to FIG. 4, the storage device may obtain a t-th momentum mₜ in the t-th DNN model parameters by performing a calculation operation using the t-th gradient data gₜ and a (t−1)-th momentum mₜ₋₁ included in the t-th iteration data. The storage device may obtain a t-th momentum variance vₜ in the t-th DNN model parameters by performing a calculation operation using the t-th gradient data gₜ and a (t−1)-th momentum variance vₜ₋₁ included in the t-th iteration data. The storage device may obtain a t-th weight wₜ in the t-th DNN model parameters by performing a calculation operation using the t-th momentum mₜ and the t-th momentum variance vₜ in the t-th DNN model parameters and a (t−1)-th weight wₜ₋₁ in the t-th iteration data.

According to at least one embodiment, the storage device may store the t-th DNN model parameters into one or more buffers. For example, the t-th momentum mₜ, the t-th momentum variance vₜ, and the t-th weight wₜ included in the t-th DNN model parameters are stored in the momentum buffer, the momentum variance buffer, and the weight buffer, respectively, for use in subsequent iterative calculations.

The storage device repeats these iterative calculation operations until an integer number of iterations of model training for the host is reached, or until a storage request or indication of completion of training is received from the host.

Then, referring back to FIG. 2, at operation S203, the storage device transmits at least a portion of the calculated DNN model parameters to the host.

According to at least one embodiment, in each iteration calculation, the storage device receives the gradient data for this iteration calculation from the host, stores all of the calculated DNN model parameters into the buffers, and transmits at least a portion of the calculated DNN model parameters (e.g., the weight wₜ in the t-th iteration calculation) to the host.

Referring back to FIG. 3, at step S306, the storage device transmits the calculated DNN model parameters to the host.

At step S307, when a storage request (e.g., a request to write the updated DNN model parameters) is received from the host, the storage device may store the calculation result to the non-volatile memory. For example, the storage device may store the DNN model parameters of the current iteration calculation result at the time that the storage request is received, to the non-volatile memory. That is, the storage device may determine the DNN model parameters of the last calculation as the updated DNN model parameters and store the updated DNN model parameters. For example, after T iteration calculations, if the storage device receives the storage request, the storage device stores T-th DNN model parameters as the updated DNN model parameters.

According to at least one embodiment, in response to a storage request from the host, the storage device determines the calculated DNN model parameters to the updated DNN model parameters, compresses the updated DNN model parameters and stores the compressed DNN model parameters in the non-volatile memory (e.g., flash memory).

As such, performing parameter calculation in DNN model training on the storage device side, transferring only necessary data between the host and the storage device, and storing a large amount of data in the storage device can greatly reduce unnecessary data transfer overhead and memory occupation of the host, and thus it is able to achieve unprecedented model scale on limited resources, reduce CPU and GPU calculation overhead and data movement, and save storage space on the host.

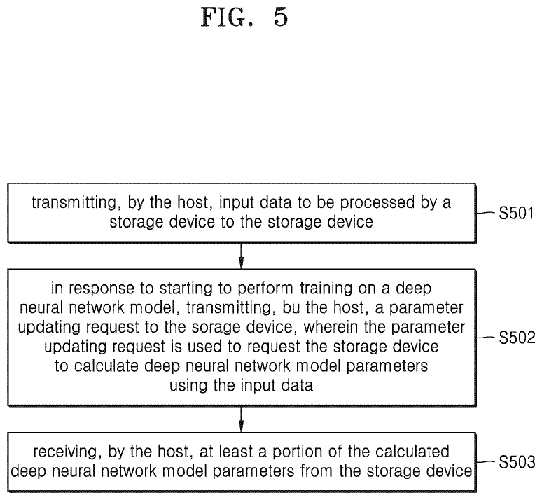

The data processing method of the storage device is described above, and the data processing method of the corresponding host will be described in detail below with reference to FIGS. 5 to 8.

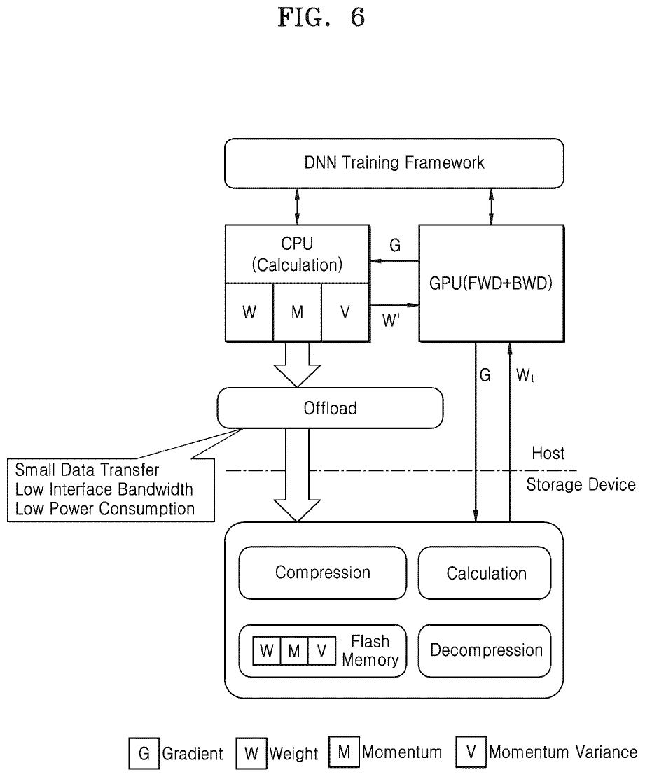

FIG. 5 is a flowchart illustrating a data processing method of a host according to at least one embodiment of the present disclosure. FIG. 6 is a schematic diagram illustrating an example implementation of a data processing method of a host according to at least one embodiment of the present disclosure.

Referring to FIG. 5, at operation S501, the host transmits input data to be processed by the storage device to the storage device.

According to at least one embodiment, the DNN model parameters may be initialized when the host determines to perform training of the DNN model. The host may initialize the DNN model parameters by using any suitable means not described in detail herein.

An example of tensor data is described in detail below. As the DNN model grow in size and complexity, sparsity becomes a most critical dimension to explore for efficiency and scalability. The sparsity in the DNN model involves introducing some sparsity on the tensor data, e.g., quantizing some tensor data with lower precision (e.g., 16 bits to 8 bits) and/or pruning the DNN model parameters by setting some or all values of some tensor data to zero, such as block sparsity or fine-grained sparsity.

According to at least one embodiment of the present disclosure, the tensor data of the DNN model parameters may have sparsity, and calculation and storage overhead may be reduced by using the sparsity. The tensor data is described below with reference to FIG. 7.

FIG. 7 is a schematic diagram illustrating tensor data in an example Visual Geometry Group (VGG) 16 network.

The tensor data may include multi-dimensional data, and the tensor data in the form of a two-dimensional matrix is used as an example in FIG. 7. Although the present disclosure only shows the tensor data in the two-dimensional form, however, the present disclosure is not limited to this. Referring to FIG. 7, a data set [3, 10], which is the sparse tensor data for the VGG 16 network, includes only two non-zero elements, i.e., [0, 3]=10 and [2, 4]=20. In FIG. 7, other squares with no values shown denote zero elements. In this case, for example, a compression rate of this tensor data may be calculated as the number of zero elements divided by the number of all elements, i.e., 14/15.

Statistically, only about 20% of the sparse tensor data in the VGG 16 network has non-zero elements. Therefore, according to the example, the sparse tensor data may be compressed for storage in the storage device.

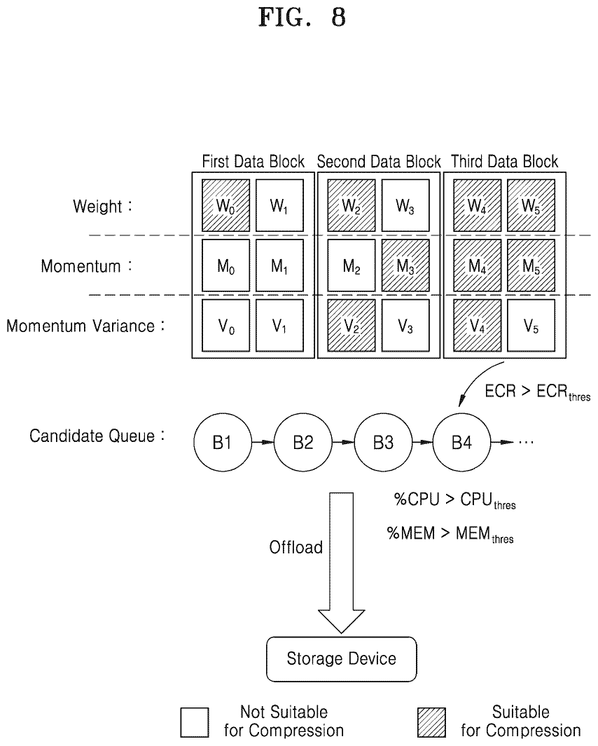

According to at least one embodiment, for a large amount of tensor data of the DNN model of a host, only sparse tensor data (e.g., sparse vectors) is offloaded to the storage device for processing. This is described in detail below with reference to FIG. 8.

FIG. 8 is a schematic diagram illustrating transmitting input data according to at least one embodiment of the present disclosure.

Referring to FIG. 8, the host divides the data of the DNN model parameters into a plurality of data blocks.

Herein, a data block may represent a set of data, for example, a batch of data.

For example, in FIG. 8, each data block includes six sub-data blocks, and each sub-data block may represent one data (e.g., one data matrix) or multiple data. For example, a first data block includes two weight sub-data blocks W₀ and W₁, two momentum sub-data blocks M₀ and M₁, and two momentum variance sub-data blocks V₀ and V₁, a second data block includes two weight sub-data blocks W₂ and W₃, two momentum sub-data blocks M₂ and M₃, and two momentum variance sub-data blocks V₂ and V₃, and a third data block includes two weight sub-data blocks W₄ and W₅, two momentum sub-data blocks M₄ and M₅, and two momentum variance sub-data blocks V₄ and V₅. Similarly, a large amount of data for the DNN model parameter may be divided into a plurality of data blocks including one or more sub-data blocks. Although the present disclosure illustrates that each data block includes various parameters, the present disclosure is not limited thereto and the data blocks may be divided in any manner.

According to at least one embodiment, the host may determine a compression rate (ECR) for each data block.

For example, the host may determine a compression rate for each sub-data block (e.g., each data matrix) by determining a percentage of zero elements of each sub-block.

For example, a host may determine the compression rate for the data block based on compression rates of sub-blocks included in the data block, e.g., the compression rate for the data block may be determined based on a sum of the compression rates of the sub-blocks.

For example, a host may determine the compression rate for the data block based on the number of sub-data blocks with a higher compression rate among the sub-data blocks, e.g., a sub-data block with a compression rate that is greater than or equal to a predetermined sub-block compression rate may be identified as the sub-data block with a higher compression rate (or referred to as a sub-data block suitable for compression), and a ratio of sub-data blocks with the higher compression rate to all sub-data blocks may be identified as the compression rate for the data block.

According to at least one embodiment, the host determines data, included in a data block for which the compression rate satisfies a compression rate threshold condition, as the input data. For example, the host may identify the data included in the data block with the compression rate greater than or equal to a predetermined data block compression rate, as the input data.

Referring to FIG. 8, the host may identify data included in a data block with an ECR greater than or equal to a predetermined compression rate threshold ECRₜₕᵣₑₛ, as the input data.

For example, when a sub-data block has a high compression rate (e.g., greater than or equal to the predetermined compression rate threshold), then the sub-data block is determined to be suitable for compression. For example, the host may determine the data block as a data block to be transmitted to the storage device, based on a fact that the number of sub-data blocks suitable for compression is greater than a predetermined number, that is, the data included in this data block is determined as the input data.

For example, referring to FIG. 8, the number of sub-data blocks suitable for compression of the first data block is 1, and the compression rate of the first data block may be represented as one of six (1/6); the number of sub-data blocks suitable for compression of the second data block is 3, and the compression rate of the second data block may be represented as one of two (1/2); the number of sub-data blocks suitable for compression of the third data block is 5, and the compression rate of the third data block may be represented as five of six (5/6). Assuming that the predetermined ECRₜₕᵣₑₛ is 2/3, only the data in the third data block may be determined as the input data.

According to at least one embodiment, when the data block to be transmitted is determined, the host adds the data block of which the compression rate satisfies the compression rate threshold condition, into a candidate queue. According to at least one embodiment, the data block that is not selected may be processed in accordance with the previous processing of the host.

Referring to FIG. 8, candidate data blocks B1, B2, and B3 already exist in the candidate queue, and when the third data block satisfies the condition, it is added to the candidate queue as a candidate data block B4.

Although there are data blocks in the candidate queue, if the current host can complete the calculation processing without using the storage device, the data blocks in the candidate queue are not transmitted to the storage device.

According to at least one embodiment, in response to a utilization rate % CPU of a central processing unit (CPU) of the host satisfying a CPU utilization threshold condition and/or a utilization rate % MEM of the memory of the host satisfying a memory utilization threshold condition, the host sequentially transmits the input data in the candidate queue to the storage device in units of data block. Referring to FIG. 8, when the utilization rate % CPU is greater than a threshold CPU utilization rate CPUₜₕᵣₑₛ and/or the utilization rate % MEM is greater than a threshold MEM utilization rate MEMₜₕᵣₑₛ, the candidate data blocks B1, B2, B3, and B4 in the candidate queue are sequentially offloaded to the storage device (e.g., an SSD).

According to at least one embodiment, the host may periodically check the CPU and/or memory usage, or the host may monitor the CPU and/or memory usage in real time, and trigger the operation of transmitting or unloading the input data once the threshold condition is satisfied.

At operation S502, in response to starting to perform training on the DNN model, the host transmits a parameter updating request to the storage device, wherein the parameter updating request is used to request the storage device to calculate the DNN model parameters using the input data.

According to at least one embodiment, in response to starting to perform the training on the DNN model, the host calculates gradient data and transmits the gradient data to the storage device. According to at least one embodiment, the gradient data is used for the storage device to calculate the DNN model parameters based on the input data. This step is described with reference to FIG. 6.

In FIG. 6, the host offloads the DNN model parameters to the storage device as described above. When the host starts to perform the training of the DNN model via a DNN training framework, a GPU of the host performs a FWD operation and/or a BWD operation and calculates the gradient data G. The GPU of the host may transmit the calculated gradient data G to the CPU and the storage device.

According to at least one embodiment, the CPU of the host may perform parameter update processing of partial DNN model parameters that cannot be transmitted to the storage device. That is, the CPU calculates a weight W′ based on the gradient data and transmits W′ to the GPU.

According to at least one embodiment, the storage device performs iterative calculation processing using the input data and the gradient data.

According to at least one embodiment, in a t-th iteration calculation, the host calculates the t-th gradient data and transmits the t-th gradient data to the storage device, wherein the t-th gradient data is used for the storage device to calculate t-th DNN model parameters in t-th iteration training calculation based on t-th iteration data.

At operation S503, the host receives at least a portion of the calculated DNN model parameters from the storage device.

According to at least one embodiment, at each iteration calculation, the host transmits the calculated gradient data in this iteration to the storage device and receives the calculated weight in this iteration from the storage device (e.g., in the t-th iteration calculation, a weight wₜ is received).

As such, performing parameter calculation in DNN model training on the storage device side, transferring only necessary data between the host and the storage device, and storing a large amount of data in the storage device can greatly reduce unnecessary data transfer overhead and memory occupation of the host, and thus it is able to achieve an unprecedented model scale on limited resources, reduce CPU and GPU calculation overhead and data movement, and save the storage space of the host. In addition, the host recognizes the sparse tensor data and stores the same in the storage device, enabling the saving of storage resources without affecting the quality of the data and the reduction of unnecessary storage space occupation.

The detailed descriptions are made on the storage device and the host according to at least one embodiments of the present disclosure below.

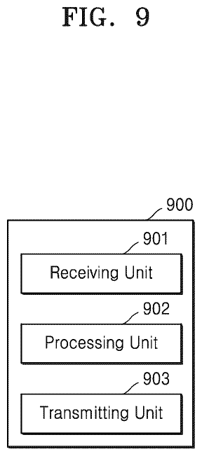

FIG. 9 is a block diagram illustrating a storage device according to at least one embodiment of the present disclosure.

Referring to FIG. 9, the storage device 900 may include a receiving unit 901, a processing unit 902, and a transmitting unit 903. Each of the receiving unit 901, the processing unit 902, and/or the transmitting unit 903 may communicate with any or all other elements described with reference to the storage device 900. For example, each of the receiving unit 901, the processing unit 902, and the transmitting unit 903 may engage in one-way and/or two-way and/or broadcast communication with each other to transfer and/or exchange and/or receive information such as but not limited to data and/or commands, in a manner such as in a serial and/or parallel manner. The information may be in encoded various formats, such as in an analog format and/or in a digital format.

According to at least one embodiment, the receiving unit 901 may be configured to receive input data to be processed by the storage device from a host, the processing unit 902 may be configured to, in response to a parameter updating request of the host in model training, calculate DNN model parameters using the input data, and the transmitting unit 903 may be configured to transmit at least a portion of the calculated DNN model parameters to the host.

That is, the receiving unit 901 may perform operations corresponding to step S201 of the data processing method described above with reference to FIG. 2, the processing unit 902 may perform operations corresponding to step S202 of the data processing method described above with reference to FIG. 2, and the transmitting unit 903 may perform operations corresponding to step S203 of the data processing method described above with reference to FIG. 2. Correspondingly, the details of the various descriptions regarding the data processing method of the storage device mentioned above may be applied to the storage device 900.

According to at least one embodiment, the storage device 900 includes a non-volatile memory (not illustrated).

According to at least one embodiment, the processing unit 902 is further configured to compress the input data and store the compressed input data in the non-volatile memory.

According to at least one embodiment, in response to the parameter updating request of the host in the model training, the processing unit 902 is configured to calculate the DNN model parameters using the input data by decompressing the compressed input data stored in the non-volatile memory in response to the parameter updating request, and calculating the DNN model parameters using the decompressed input data, and wherein, the processing unit 902 is further configured to determine the calculated DNN model parameters as updated DNN model parameters in response to a storage request of the host, compress the updated DNN model parameters, and store the compressed DNN model parameters in the non-volatile memory.

According to at least one embodiment, the receiving unit 901 is configured to receive the input data to be processed by the storage device from the host, by receiving the input data in units of data blocks, wherein a compression rate of each data block satisfies a compression rate threshold condition.

According to at least one embodiment, the processing unit 902 is configured to, in response to the parameter updating request of the host in the model training, calculate the DNN model parameters using the input data, by, in response to the parameter updating request of the host, calculating the DNN model parameters using the input data and gradient data received from the host.

According to at least one embodiment, the processing unit 902 is configured to, in response to the parameter updating request of the host, calculate the DNN model parameters using the input data and the gradient data received from the host, by: in response to the parameter updating request, iteratively calculating the DNN model parameters using the input data and the gradient data received from the host, wherein, in a t-th iteration calculation, the processing unit is configured to calculate t-th DNN model parameters using t-th iteration data and t-th gradient data received from the host, wherein t is an integer greater than or equal to 1 and less than or equal to the number of iterations of model training of the host, wherein the t-th iteration data is the input data when t is equal to 1, and the t-th iteration data is (t−1)-th DNN model parameters when t is not equal to 1.

According to at least one embodiment, the t-th iteration data comprises momentum, momentum variance, and weight, wherein the processing unit 902 is configured to calculate the t-th DNN model parameters using the t-th iteration data and the t-th gradient data received from the host by: obtaining momentum and momentum variance in the t-th DNN model parameters, by performing a calculation operation using the t-th gradient data and the momentum and the momentum variance comprised in the t-th iteration data; obtaining weight in the t-th DNN model parameters, by performing a calculation operation using the momentum and the momentum variance in the t-th DNN model parameters and the weight in the t-th iteration data.

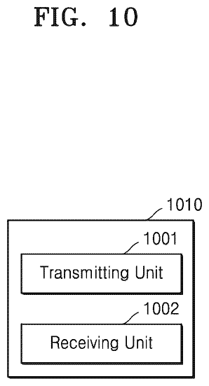

FIG. 10 is a block diagram illustrating a storage device according to at least one embodiment of the present disclosure.

Referring to FIG. 10, the host 1010 may include a transmitting unit 1001 and a receiving unit 1002. Each of the transmitting unit 1001 and/or the receiving unit 1002 may communicate with any or all other elements described with reference to the host 1010. For example, each of the transmitting unit 1001 and/or the receiving unit 1002 may engage in one-way and/or two-way and/or broadcast communication with each other to transfer and/or exchange and/or receive information such as but not limited to data and/or commands, in a manner such as in a serial and/or parallel manner. The information may be in encoded various formats, such as in an analog format and/or in a digital format.

According to at least one embodiment, the transmitting unit 1001 may be configured to transmit input data to be processed by a storage device to the storage device, and in response to starting to perform training on a deep neural network DNN model, transmit a parameter updating request to the storage device, wherein the parameter updating request is used to request the storage device to calculate DNN model parameters using the input data, and the receiving unit 1002 may be configured to receive at least a portion of the calculated DNN model parameters from the storage device.

That is, the transmitting unit 1001 may perform operations corresponding to step S501 of the data processing method described above with reference to FIG. 5, and the receiving unit 1002 may perform operations corresponding to step S502 of the data processing method described above with reference to FIG. 5. Correspondingly, the details of the various descriptions regarding the data processing method of the host mentioned above may be applied to the host 1010.

According to at least one embodiment, the transmitting unit 1001 is further configured to transmit a storage request for DNN model parameters to the storage device in response to determining completion of model training, wherein the storage request is used for the storage device to determine the calculated DNN model parameters as updated DNN model parameters, compress the updated DNN model parameters, and store the compressed DNN model parameters in a non-volatile memory of the storage device.

According to at least one embodiment, the host 1010 may further include a data unit configured to divide data of the DNN model parameters into a plurality of data blocks; determine a compression rate of each data block; determine data comprised in a data block, of which the compression rate satisfies a compression rate threshold condition, as the input data.

According to at least one embodiment, the transmitting unit 1001 is configured to transmit the input data to be processed by the storage device to the storage device by: adding the data block, of which the compression rate satisfies the compression rate threshold condition, into a candidate queue; in response to a utilization rate of a central processing unit (CPU) of the host satisfying a CPU utilization threshold condition and/or a utilization rate of a memory of the host satisfying a memory utilization threshold condition, sequentially transmit the input data in the candidate queue to the storage device in units of data block.

According to at least one embodiment, the host 1010 further includes a processing unit configured to: in response to starting to perform training on the DNN model, calculate gradient data, and the transmitting unit 1001 is configured to transmit the gradient data to the storage device, wherein the gradient data is used for the storage device to calculate the DNN model parameters based on the input data.

According to at least one embodiment, the processing unit and the transmitting unit 1001 are configured to, in response to starting to perform training on the DNN model, calculate the gradient data and transmit the gradient data to the storage device by: calculating, by the processing unit, t-th gradient data and transmitting, by the transmitting unit 1001, the t-th gradient data to the storage device, wherein the t-th gradient data is used for the storage device to calculate t-th DNN model parameters based on t-th iteration data in t-th iteration training calculation, wherein t is an integer greater than or equal to 1 and less than or equal to the number of iterations of model training of the host, wherein the t-th iteration data is the input data when t is equal to 1, and the t-th iteration data is (t−1)-th DNN model parameters when t is not equal to 1.

In some embodiments, the storage device 900 may correspond to the storage device in FIGS. 2 to 6 and 8, and the host 1010 may correspond to the host in FIGS. 3, 5 to 8. The specific manners in which each unit performs operations in the above embodiments have been described in detail in at least one embodiments of the related data processing method discussed above, and will therefore not be elaborated here.

In addition, it should be understood that individual units in the storage device 900 and host 1010 according to the example embodiments of the present disclosure may be implemented with hardware components and/or software components. A person skilled in the art may, for example, use a field programmable gate array (FPGA) and/or an application-specific integrated circuit (ASIC) to implement the processing circuitry of the individual units, depending on the processing performed by the defined individual units.

According to at least one embodiment of the present disclosure, a system to which a storage device is applied, may also be provided, the system includes: a main processor; a memory; and a storage device, wherein the main processor is configured to control the storage device to perform the processing data method of the storage device as described above and/or the host processor is configured to perform the processing data method of the host as described above.

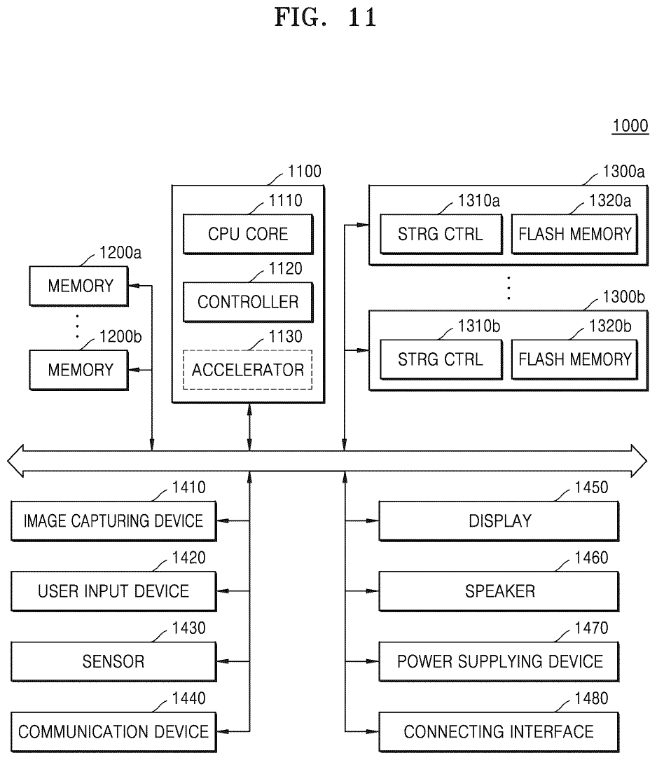

FIG. 11 is a diagram of a system 1000 to which a storage device is applied, according to at least one embodiment.

The system 1000 of FIG. 11 may basically be a mobile system, such as a portable communication terminal (e.g., a mobile phone), a smartphone, a tablet personal computer (PC), a wearable device, a healthcare device, or an Internet of things (IOT) device. However, the system 1000 of FIG. 11 is not necessarily limited to the mobile system and may be a PC, a laptop computer, a server, a media player, or an automotive device (e.g., a navigation device). In at least some embodiments, the system 1000 may be configured to be trained to perform voice recognition, image recognition, image classification, image processing, automated responses, self-driving, etc. using a DNN.

Referring to FIG. 11, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory)s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 1000 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

In some embodiments, the memories 1200a and 1200b, and/or the storage devices 1300a and 1300b, may correspond to the storage devices in FIGS. 2 to 6 and 8 or the storage device 900 in FIG. 9, and the main processor 1100 may correspond to the host in FIGS. 3, 5 to 8, or the host 1010 in FIG. 10.

According to at least one embodiment of the present disclosure, a host storage system may also be provided, the host storage system includes: a storage device and a host configured to control the storage device according to the data processing method of the host as described above.

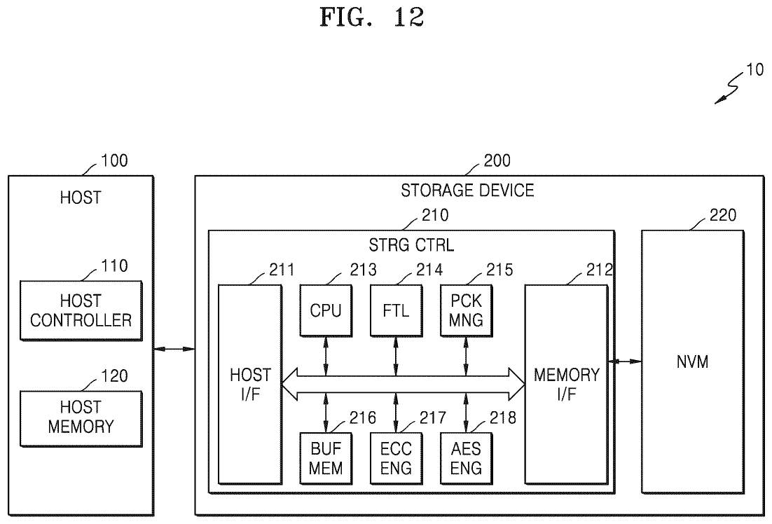

FIG. 12 is a block diagram of a host storage system 10 according to at least one example embodiment.

The host storage system 10 may include a host 100 and a storage device 200. Further, the storage device 200 may include a storage controller 210 and an NVM 220. According to an example embodiment, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to at least one embodiment, the host controller 110 and the host memory 120 may be implemented as separate semiconductor chips. Alternatively, in some embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory (not shown) in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

In some embodiments, storage device 20 may correspond to the storage devices in FIGS. 2 to 6 and 8 or the storage device 900 in FIG. 9, and the host 100 may correspond to the host in FIGS. 3, 5 to 8, or the host 1010 in FIG. 10.

According to at least one embodiment of the present disclosure, a memory system may also be provided, the memory system includes a memory device and a memory controller. The memory controller is configured to control the memory device to perform the data processing method of the storage device as described above.

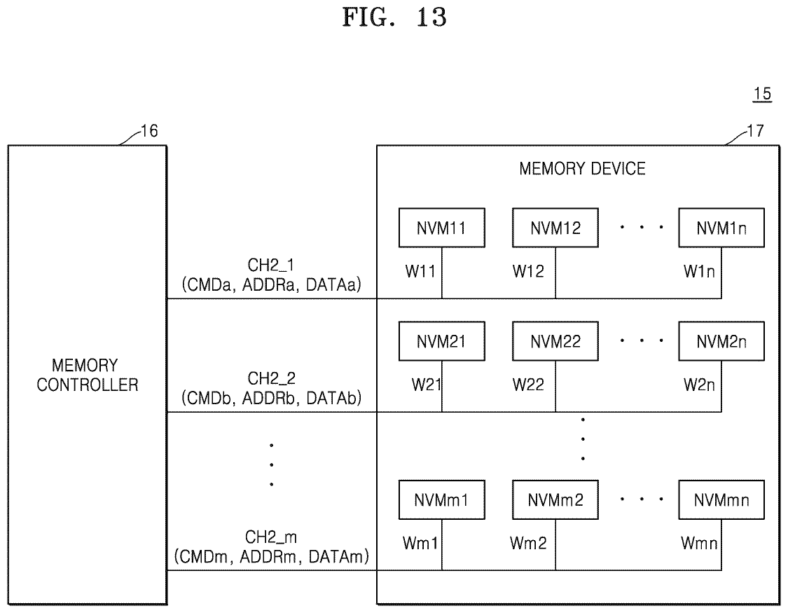

FIG. 13 is a block diagram of a memory system 15 according to at least one embodiment.

Referring to FIG. 13, the memory system 15 may include a memory device 17 and a memory controller 16. The memory system 15 may support a plurality of channels CH1 to CHm, and the memory device 17 may be connected to the memory controller 16 through the plurality of channels CH1 to CHm. For example, the memory system 15 may be implemented as a storage device, such as an SSD.

The memory device 17 may include a plurality of NVM devices NVM11 to NVMmn. Each of the NVM devices NVM11 to NVMmn may be connected to one of the plurality of channels CH1 to CHm through a way corresponding thereto. For instance, the NVM devices NVM11 to NVM1n may be connected to a first channel CH1 through ways W11 to W1n, and the NVM devices NVM21 to NVM2n may be connected to a second channel CH2 through ways W21 to W2n. In an example embodiment, each of the NVM devices NVM11 to NVMmn may be implemented as an arbitrary memory unit that may operate according to an individual command from the memory controller 16. For example, each of the NVM devices NVM11 to NVMmn may be implemented as a chip or a die, but the inventive concept is not limited thereto.

The memory controller 16 may transmit and receive signals to and from the memory device 17 through the plurality of channels CH1 to CHm. For example, the memory controller 16 may transmit commands CMDa to CMDm, addresses ADDRa to ADDRm, and data DATAa to DATAm to the memory device 17 through the channels CH1 to CHm or receive the data DATAa to DATAm from the memory device 17.

The memory controller 16 may select one of the NVM devices NVM11 to NVMmn, which is connected to each of the channels CH1 to CHm, by using a corresponding one of the channels CH1 to CHm, and transmit and receive signals to and from the selected NVM device. For example, the memory controller 16 may select the NVM device NVM11 from the NVM devices NVM11 to NVM1n connected to the first channel CH1. The memory controller 16 may transmit the command CMDa, the address ADDRa, and the data DATAa to the selected NVM device NVM11 through the first channel CH1 or receive the data DATAa from the selected NVM device NVM11.

The memory controller 16 may transmit and receive signals to and from the memory device 17 in parallel through different channels. For example, the memory controller 16 may transmit a command CMDb to the memory device 17 through the second channel CH2 while transmitting a command CMDa to the memory device 17 through the first channel CH1. For example, the memory controller 16 may receive data DATAb from the memory device 17 through the second channel CH2 while receiving data DATAa from the memory device 17 through the first channel CH1.

The memory controller 16 may control all operations of the memory device 17. The memory controller 16 may transmit a signal to the channels CH1 to CHm and control each of the NVM devices NVM11 to NVMmn connected to the channels CH1 to CHm. For instance, the memory controller 16 may transmit the command CMDa and the address ADDRa to the first channel CH1 and control one selected from the NVM devices NVM11 to NVM1n.

Each of the NVM devices NVM11 to NVMmn may operate via the control of the memory controller 16. For example, the NVM device NVM11 may program the data DATAa based on the command CMDa, the address ADDRa, and the data DATAa provided to the first channel CH1. For example, the NVM device NVM21 may read the data DATAb based on the command CMDb and the address ADDb provided to the second channel CH2 and transmit the read data DATAb to the memory controller 16.

Although FIG. 13 illustrates an example in which the memory device 17 communicates with the memory controller 16 through m channels and includes n NVM devices corresponding to each of the channels, the number of channels and the number of NVM devices connected to one channel may be variously changed.

In some embodiments, the memory device 17 may correspond to the storage device in FIGS. 2 to 6 and 8, or the storage device 900 in FIG. 9.

According to at least one embodiment of the present disclosure, a universal flash storage (UFS) system may also be provided, the UFS system includes: a UFS Host; a UFS device; and a UFS interface that connects the UFS host with the UFS device. The UFS device is configured to perform the data processing method of the storage device as described above, and/or the UFS host is configured to perform the data processing method of the host as described above.

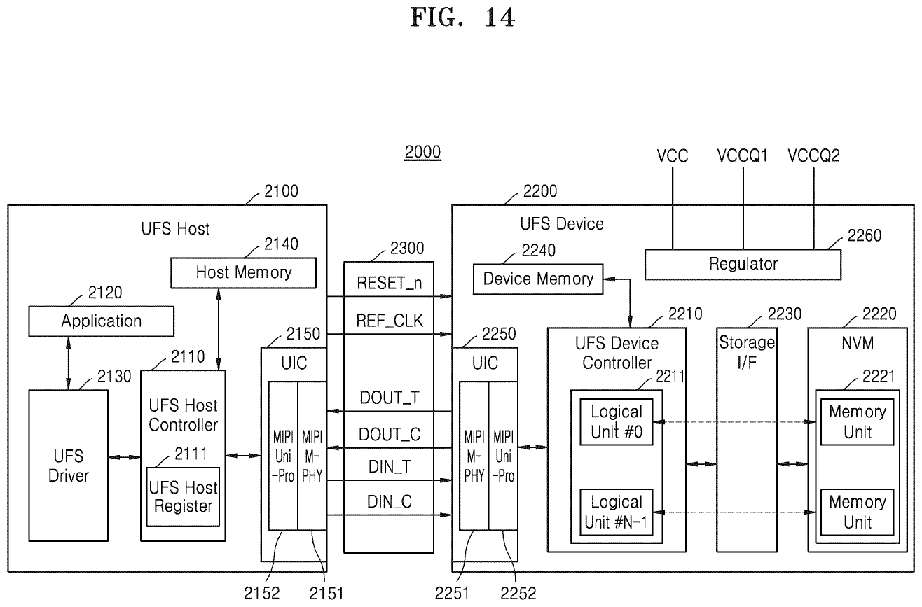

FIG. 14 is a diagram of a UFS system 2000 according to at least one embodiment. The UFS system 2000 may be a system conforming to a UFS standard announced by Joint Electron Device Engineering Council (JEDEC) and include a UFS host 2100, a UFS device 2200, and a UFS interface 2300. The above description of the system 1000 of FIG. 11 may also be applied to the UFS system 2000 of FIG. 14 within a range that does not conflict with the following description of FIG. 14.

Referring to FIG. 14, the UFS host 2100 may be connected to the UFS device 2200 through the UFS interface 2300. When the main processor 1100 of FIG. 11 is an AP, the UFS host 2100 may be implemented as a portion of the AP. The UFS host controller 2110 and the host memory 2140 may respectively correspond to the controller 1120 of the main processor 1100 and the memories 1200a and 1200b of FIG. 11. The UFS device 2200 may correspond to the storage device 1300a and 1300b of FIG. 11, and a UFS device controller 2210 and an NVM 2220 may respectively correspond to the storage controllers 1310a and 1310b and the NVMs 1320a and 1320b of FIG. 11.

The UFS host 2100 may include a UFS host controller 2110, an application 2120, a UFS driver 2130, a host memory 2140, and a UFS interconnect (UIC) layer 2150. The UFS device 2200 may include the UFS device controller 2210, the NVM 2220, a storage interface 2230, a device memory 2240, a UIC layer 2250, and a regulator 2260. The NVM 2220 may include a plurality of memory units 2221. Although each of the memory units 2221 may include a V-NAND flash memory having a 2D structure or a 3D structure, each of the memory units 2221 may include another kind of NVM, such as PRAM and/or RRAM. The UFS device controller 2210 may be connected to the NVM 2220 through the storage interface 2230. The storage interface 2230 may be configured to comply with a standard protocol, such as Toggle or ONFI.

The application 2120 may refer to a program that wants to communicate with the UFS device 2200 to use functions of the UFS device 2200. The application 2120 may transmit input-output requests (IORs) to the UFS driver 2130 for input/output (I/O) operations on the UFS device 2200. The IORs may refer to a data read request, a data storage (or write) request, and/or a data erase (or discard) request, without being limited thereto.

The UFS driver 2130 may manage the UFS host controller 2110 through a UFS-host controller interface (UFS-HCl). The UFS driver 2130 may convert the IOR generated by the application 2120 into a UFS command defined by the UFS standard and transmit the UFS command to the UFS host controller 2110. One IOR may be converted into a plurality of UFS commands. Although the UFS command may basically be defined by an SCSI standard, the UFS command may be a command dedicated to the UFS standard.

The UFS host controller 2110 may transmit the UFS command converted by the UFS driver 2130 to the UIC layer 2250 of the UFS device 2200 through the UIC layer 2150 and the UFS interface 2300. During the transmission of the UFS command, a UFS host register 2111 of the UFS host controller 2110 may serve as a command queue (CQ).

The UIC layer 2150 on the side of the UFS host 2100 may include a mobile industry processor interface (MIPI) M-PHY 2151 and an MIPI UniPro 2152, and the UIC layer 2250 on the side of the UFS device 2200 may also include an MIPI M-PHY 2251 and an MIPI UniPro 2252.

The UFS interface 2300 may include a line configured to transmit a reference clock signal REF_CLK, a line configured to transmit a hardware reset signal RESET_n for the UFS device 2200, a pair of lines configured to transmit a pair of differential input signals DIN_t and DIN_c, and a pair of lines configured to transmit a pair of differential output signals DOUT_t and DOUT_c.

A frequency of a reference clock signal REF_CLK provided from the UFS host 2100 to the UFS device 2200 may be one of 19.2 MHz, 26 MHz, 38.4 MHz, and 52 MHz, without being limited thereto. The UFS host 2100 may change the frequency of the reference clock signal REF_CLK during an operation, that is, during data transmission/receiving operations between the UFS host 2100 and the UFS device 2200. The UFS device 2200 may generate cock signals having various frequencies from the reference clock signal REF_CLK provided from the UFS host 2100, by using a phase-locked loop (PLL). Also, the UFS host 2100 may set a data rate between the UFS host 2100 and the UFS device 2200 by using the frequency of the reference clock signal REF_CLK. That is, the data rate may be determined depending on the frequency of the reference clock signal REF_CLK.

The UFS interface 2300 may support a plurality of lanes, each of which may be implemented as a pair of differential lines. For example, the UFS interface 2300 may include at least one receiving lane and at least one transmission lane. In FIG. 14, a pair of lines configured to transmit a pair of differential input signals DIN_T and DIN_C may constitute a receiving lane, and a pair of lines configured to transmit a pair of differential output signals DOUT_T and DOUT_C may constitute a transmission lane. Although one transmission lane and one receiving lane are illustrated in FIG. 14, the number of transmission lanes and the number of receiving lanes may be changed.

The receiving lane and the transmission lane may transmit data based on a serial communication scheme. Full-duplex communications between the UFS host 2100 and the UFS device 2200 may be enabled due to a structure in which the receiving lane is separated from the transmission lane. That is, while receiving data from the UFS host 2100 through the receiving lane, the UFS device 2200 may transmit data to the UFS host 2100 through the transmission lane. In addition, control data (e.g., a command) from the UFS host 2100 to the UFS device 2200 and user data to be stored in or read from the NVM 2220 of the UFS device 2200 by the UFS host 2100 may be transmitted through the same lane. Accordingly, between the UFS host 2100 and the UFS device 2200, there may be no need to further provide a separate lane for data transmission in addition to a pair of receiving lanes and a pair of transmission lanes.

The UFS device controller 2210 of the UFS device 2200 may control all operations of the UFS device 2200. The UFS device controller 2210 may manage the NVM 2220 by using a logical unit (LU) 2211, which is a logical data storage unit. The number of LUs 2211 may be 8, without being limited thereto. The UFS device controller 2210 may include an FTL and convert a logical data address (e.g., a logical block address (LBA)) received from the UFS host 2100 into a physical data address (e.g., a physical block address (PBA)) by using address mapping information of the FTL. A logical block configured to store user data in the UFS system 2000 may have a size in a predetermined range. For example, a minimum size of the logical block may be set to 4 Kbyte.

When a command from the UFS host 2100 is applied through the UIC layer 2250 to the UFS device 2200, the UFS device controller 2210 may perform an operation in response to the command and transmit a completion response to the UFS host 2100 when the operation is completed.

As an example, when the UFS host 2100 initiates the storing of user data in the UFS device 2200, the UFS host 2100 may transmit a data storage command to the UFS device 2200. When a response (a ‘ready-to-transfer’ response) indicating that the UFS host 2100 is ready to receive user data (ready-to-transfer) is received from the UFS device 2200, the UFS host 2100 may transmit user data to the UFS device 2200. The UFS device controller 2210 may temporarily store the received user data in the device memory 2240 and store the user data, which is temporarily stored in the device memory 2240, at a selected position of the NVM 2220 based on the address mapping information of the FTL.

As another example, when the UFS host 2100 initiates a read operation of the user data stored in the UFS device 2200, the UFS host 2100 may transmit a data read command to the UFS device 2200. The UFS device controller 2210, which has received the command, may read the user data from the NVM 2220 based on the data read command and temporarily store the read user data in the device memory 2240. During the read operation, the UFS device controller 2210 may detect and correct an error in the read user data by using an ECC engine (not shown) embedded therein. More specifically, the ECC engine may generate parity bits for write data to be written to the NVM 2220, and the generated parity bits may be stored in the NVM 2220 along with the write data. During the reading of data from the NVM 2220, the ECC engine may correct an error in read data by using the parity bits read from the NVM 2220 along with the read data, and output error-corrected read data.

In addition, the UFS device controller 2210 may transmit user data, which is temporarily stored in the device memory 2240, to the UFS host 2100. In addition, the UFS device controller 2210 may further include an AES engine (not shown). The AES engine may perform at least of an encryption operation and a decryption operation on data transmitted to the UFS device controller 2210 by using a symmetric-key algorithm.

The UFS host 2100 may sequentially store commands, which are to be transmitted to the UFS device 2200, in the UFS host register 2111, which may serve as a common queue, and sequentially transmit the commands to the UFS device 2200. In this case, even while a previously transmitted command is still being processed by the UFS device 2200, that is, even before receiving a notification that the previously transmitted command has been processed by the UFS device 2200, the UFS host 2100 may transmit a next command, which is on standby in the CQ, to the UFS device 2200. Thus, the UFS device 2200 may also receive a next command from the UFS host 2100 during the processing of the previously transmitted command. A maximum number (or queue depth) of commands that may be stored in the CQ may be, for example, 32. Also, the CQ may be implemented as a circular queue in which a start and an end of a command line stored in a queue are indicated by a head pointer and a tail pointer.

Each of the plurality of memory units 2221 may include a memory cell array (not shown) and a control circuit (not shown) configured to control an operation of the memory cell array. The memory cell array may include a 2D memory cell array or a 3D memory cell array. The memory cell array may include a plurality of memory cells. Although each of the memory cells is a single-level cell (SLC) configured to store 1-bit information, each of the memory cells may be a cell configured to store information of 2 bits or more, such as a multi-level cell (MLC), a triple-level cell (TLC), and a quadruple-level cell (QLC). The 3D memory cell array may include a vertical NAND string in which at least one memory cell is vertically oriented and located on another memory cell.

Voltages VCC, VCCQ, and VCCQ2 may be applied as power supply voltages to the UFS device 2200. The voltage VCC may be a main power supply voltage for the UFS device 2200 and be in a range of 2.4 V to 3.6 V. The voltage VCCQ may be a power supply voltage for supplying a low voltage mainly to the UFS device controller 2210 and be in a range of 1.14 V to 1.26 V. The voltage VCCQ2 may be a power supply voltage for supplying a voltage, which is lower than the voltage VCC and higher than the voltage VCCQ, mainly to an I/O interface, such as the MIPI M-PHY 2251, and be in a range of 1.7 V to 1.95 V. The power supply voltages may be supplied through the regulator 2260 to respective components of the UFS device 2200. The regulator 2260 may be implemented as a set of unit regulators respectively connected to different ones of the power supply voltages described above.

In some embodiments, the UFS device 2200 may correspond to the storage device in FIGS. 2 to 6 and 8, or the storage device 900 in FIG. 9, and the UFS host 2100 may correspond to the host in FIGS. 3, 5 to 8, or the host 1010 in FIG. 10.

According to at least one embodiment of the present disclosure, an electronic apparatus is also provided, the electronic apparatus includes: at least one processor; at least one memory storing computer executable instructions. The computer executable instructions, when being executed by the at least one processor, cause the at least one processor to perform the data processing method as described above.

According to at least one embodiment of the present disclosure, the electronic apparatus may be a PC computer, a tablet apparatus, a personal digital assistant, a smartphone, or other apparatuses capable of executing the set of instructions described above. Here, the electronic apparatus does not have to be a single electronic apparatus, but can also be any collection of apparatuses or circuits capable of executing the above instructions (or set of instructions) individually or jointly. The electronic apparatus may also be part of an integrated control system or system manager, or a portable electronic apparatus that may be configured to be interconnected with an interface locally or remotely (e.g., via wireless transmission).

In the electronic apparatus, a processor may include a central processing unit (CPU), a graphics processing unit (GPU), a programmable logic device, a dedicated processor system, a microcontroller, or a microprocessor. By way of example and not limitation, the processor may also include an analog processor, a digital processor, a microprocessor, a multi-core processor, a processor array, a network processor, and the like.

The processor may run instructions or code stored in memory, wherein the memory may also store data. The instructions and data may also be sent and received over a network via a network interface device, wherein the network interface device may utilize any known transmission protocol.

The memory may be integrated with the processor, for example, by arranging RAM or flash memory within an integrated circuit microprocessor. In addition, the memory may comprise a separate device, such as, for example, an external disk drive, a storage array, or other storage device that may be used by any database system. The memory and the processor may be operationally coupled or may communicate with each other, for example, via I/O ports, network connections, etc., enabling the processor to read files stored in the memory.

In addition, the electronic apparatus may include a video display (e.g., a liquid crystal display) and a user interaction interface (e.g., a keyboard, a mouse, a touch input device, etc.). All components of the electronic apparatus may be connected to each other via a bus and/or network.

According to at least one embodiment of the present disclosure, a computer-readable storage medium may also be provided, wherein, instructions in the computer-readable storage medium, when being executed by at least one processor, cause the at least one processor to perform the data processing method as described above.

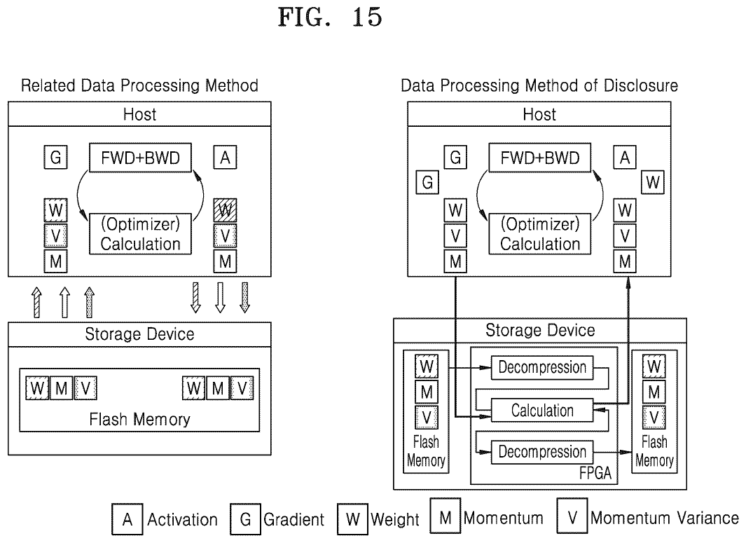

FIG. 15 is a schematic diagram illustrating memory usage statistics of various networks.

As can be seen with reference to FIG. 15, by using at least one embodiment according to the present disclosure, an upper limit of storage capacity during training process of the original network can be increased. For example, a dashed line shows an upper limit of memory capacity to which at least one embodiment according to the present disclosure is applied.

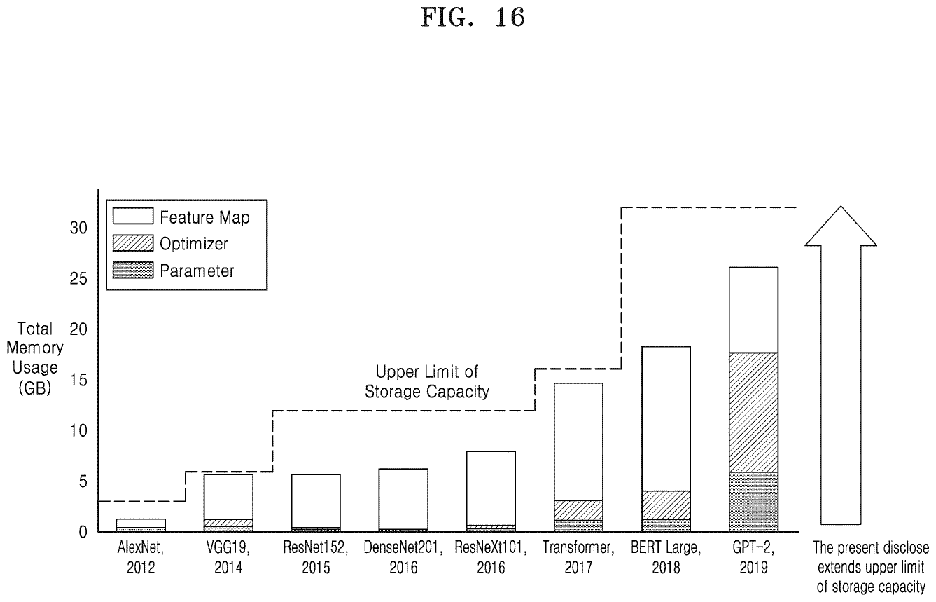

FIG. 16 is a schematic diagram illustrating a comparison of the related data processing method and a data processing method according to at least one embodiment of the present disclosure.

Referring to FIG. 16, in the related data processing method, when a host performs iterative calculation regarding DNN model parameters during DNN model training, it is necessary to read the DNN model parameters (e.g., weight W, momentum M, and momentum variance V) multiple times from a flash memory of a storage device (e.g., an SSD), and to write the calculated DNN model parameters (e.g., the weight W, momentum M, and momentum variance V) multiple times to the flash memory of the storage device (e.g., SSD), such repeated data transfers consume significant resources.

In at least one embodiment according to the present disclosure, the host only needs to offload input data (e.g., weights W, momentum M, and momentum variance V) of the DNN model parameters to a non-volatile memory (e.g., flash memory) in a storage device (e.g., SSD) in an initial stage, and only needs to transmit the gradient data and receive the weight data during subsequent iterations calculation, without requiring a large amount of data transfer, and the host and the storage device may work together to improve the efficiency of DNN model parameter calculation, thereby improving the efficiency of overall DNN model training.

After considering the description and practicing the present invention disclosed herein, those skilled in the art are easily think of other embodiments of the present disclosure. The present application intends to cover any variation, use or adaptation of the present disclosure, which follow general principles of the present disclosure and include the common general knowledge or frequently used technical means in the technical field, which are not disclosed in the present disclosure. The description and at least one embodiment are only regarded as example, and the true scope and spirit of the present disclosure are indicated by the claims.

It should be understood that the present disclosure is not limited to the example structures described above and shown in the drawings, and various modifications and changes may be made without departing from its scope. The scope of the present disclosure is limited only by the claims.

1. A data processing method of a storage device, comprising:
receiving, by the storage device, input data to be processed by the storage device;
calculating, by the storage device, deep neural network (DNN) model parameters using the input data in response to a parameter updating request of a host in model training; and
transmitting, by the storage device, at least a portion of the calculated DNN model parameters to the host.

2. The data processing method according to claim 1, wherein the storage device comprises a non-volatile memory,
wherein the data processing method further comprises
compressing, by the storage device, the input data, and
storing the compressed input data in the non-volatile memory,
wherein, in response to the parameter updating request of the host in the model training, the calculating, by the storage device, the DNN model parameters using the input data comprises
decompressing the compressed input data stored in the non-volatile memory in response to the parameter updating request, and
calculating the DNN model parameters using the decompressed input data, and wherein the data processing method further comprises
determining, by the storage device, the calculated DNN model parameters as updated DNN model parameters in response to a storage request of the host,
compressing the updated DNN model parameters, and
storing the compressed DNN model parameters in the non-volatile memory.

3. The data processing method according to claim 1, wherein the receiving the input data to be processed by the storage device:
receiving the input data in units of data blocks, wherein a compression rate of at least some of the data blocks satisfy a compression rate threshold condition.

4. The data processing method according to claim 1, wherein, the calculating, by the storage device, the DNN model parameters using the input data in response to the parameter updating request of the host in the model training comprises:
calculating the DNN model parameters using the input data and gradient data received from the host.

5. The data processing method according to claim 4, wherein, the calculating the DNN model parameters using the input data and the gradient data received from the host comprises:
iteratively calculating the DNN model parameters using the input data and the gradient data received from the host in response to the parameter updating request, such that, in a t-th iteration calculation, the storage device calculates t-th DNN model parameters using t-th iteration data and t-th gradient data received from the host,
wherein t is an integer greater than or equal to 1 and less than or equal to a number of iterations of model training of the host,
wherein the t-th iteration data is the input data when t is equal to 1, and the t-th iteration data is (t−1)-th DNN model parameters when t is not equal to 1.

6. The data processing method according to claim 5, wherein the t-th iteration data comprises momentum, momentum variance, and weight,
wherein calculating the t-th DNN model parameters using the t-th iteration data and the t-th gradient data received from the host comprises:
obtaining momentum and momentum variance in the t-th DNN model parameters by performing a calculation operation using the t-th gradient data and the momentum and the momentum variance comprised in the t-th iteration data; and
obtaining weight in the t-th DNN model parameters by performing a calculation operation using the momentum and the momentum variance in the t-th DNN model parameters and the weight in the t-th iteration data.

7.-12. (canceled)

13. A storage device, comprising:
a receiving unit configured to receive input data to be processed by the storage device;
a processing unit configured to calculate deep neural network (DNN) model parameters using the input data in response to a parameter updating request of a host in model training; and
a transmitting unit configured to transmit at least a portion of the calculated DNN model parameters to the host.

14. The storage device according to claim 13, wherein the storage device comprises a non-volatile memory,
wherein the processing unit is further configured to compress the input data and store the compressed input data in the non-volatile memory,
wherein, in response to the parameter updating request of the host in the model training, the processing unit is configured to calculate the DNN model parameters using the input data by
decompressing the compressed input data stored in the non-volatile memory, and
calculating the DNN model parameters using the decompressed input data, and
wherein the processing unit is further configured to
determine the calculated DNN model parameters as updated DNN model parameters in response to a storage request of the host,
compress the updated DNN model parameters, and
store the compressed DNN model parameters in the non-volatile memory.

15. The storage device according to claim 13, wherein the receiving unit is configured to receive the input data to be processed by the storage device from the host in response to a compression rate of each data block being greater than or equal to a compression rate threshold.

16. The storage device according to claim 13, wherein, the processing unit is configured to calculate the DNN model parameters using the input data, in response to the parameter updating request of the host in the model training, by calculating the DNN model parameters using the input data and gradient data received from the host.

17. The storage device according to claim 16, wherein, the processing unit is configured to, in response to the parameter updating request of the host, calculate the DNN model parameters using the input data and the gradient data received from the host, by:
iteratively calculating the DNN model parameters using the input data and the gradient data received from the host in response to the parameter updating request,
wherein, in a t-th iteration calculation, the processing unit is configured to calculate t-th DNN model parameters using t-th iteration data and t-th gradient data received from the host,
wherein t is an integer greater than or equal to 1 and less than or equal to a number of iterations of model training of the host,
wherein the t-th iteration data is the input data when t is equal to 1, and the t-th iteration data is (t−1)-th DNN model parameters when t is not equal to 1.

18. The storage device according to claim 17, wherein the t-th iteration data comprises momentum, momentum variance, and weight,
wherein the processing unit is configured to calculate the t-th DNN model parameters using the t-th iteration data and the t-th gradient data received from the host by
obtaining momentum and momentum variance in the t-th DNN model parameters, by performing a calculation operation using the t-th gradient data and the momentum and the momentum variance comprised in the t-th iteration data, and
obtaining weight in the t-th DNN parameters, by performing a calculation operation using the momentum and the momentum variance in the t-th DNN model parameters and the weight in the t-th iteration data.

19. A host, comprising:
a transmitting unit configured to transmit input data to be processed by a storage device to the storage device, and transmit a parameter updating request to the storage device in response to starting to perform training on a deep neural network (DNN) model, wherein the parameter updating request is used to request the storage device to calculate DNN model parameters using the input data; and
a receiving unit configured to receive at least a portion of the calculated DNN model parameters from the storage device.

20. The host according to claim 19, wherein the transmitting unit is further configured to:
transmit a storage request for DNN model parameters to the storage device in response to determining completion of model training, and
wherein the storage request is configured to initiate the storage device to determine the calculated DNN model parameters as updated DNN model parameters, compress the updated DNN model parameters, and store the compressed DNN model parameters in a non-volatile memory of the storage device.

21. The host according to claim 20, wherein the host further comprises a data unit configured to:
divide data of the DNN model parameters into a plurality of data blocks;
determine a compression rate of each data block; and
assign data comprised in a data block, of which the compression rate satisfies a compression rate threshold condition, as the input data.

22. The host according to claim 21, wherein the transmitting unit is configured to transmit the input data to be processed by the storage device to the storage device by:
adding the data block, of which the compression rate satisfies the compression rate threshold condition, into a candidate queue; and
sequentially transmitting the input data in the candidate queue to the storage device in units of data block in response to a determination that a utilization rate of a central processing unit (CPU) of the host satisfying a CPU utilization threshold condition and/or that a utilization rate of a memory of the host satisfying a memory utilization threshold condition.

23. The host according to claim 19, wherein the host comprises a processing unit configured to:
calculate gradient data in response to starting to perform training on the DNN model,
wherein the transmitting unit is configured to transmit the gradient data to the storage device, and
wherein the gradient data is configured to enable the storage device to calculate the DNN model parameters based on the input data.

24. The host according to claim 23, wherein, the processing unit and the transmitting unit are configured to calculate the gradient data and transmit the gradient data to the storage device by:
calculating, by the processing unit, t-th gradient data and transmitting, by the transmitting unit, the t-th gradient data to the storage device,
wherein the t-th gradient data is used for the storage device to calculate t-th DNN model parameters based on t-th iteration data in t-th iteration training calculation,
wherein t is an integer greater than or equal to 1 and less than or equal to a number of iterations of model training of the host, and
wherein the t-th iteration data is the input data when t is equal to 1, and the t-th iteration data is (t−1)-th DNN model parameters when t is not equal to 1.

25.-30. (canceled)
